(19) United States
(12) Patent Application Publication
(10) Pub. No.: US 2008/0018550 A1
(43) Pub. Date: Jan. 24, 2008

(54) Antenna apparatus

(75) Inventor: Shotaro Horii, Kobe-shi (JP)

Correspondence Address: BIRCH STEWART KOLASCH & BIRCH, PO BOX 747, FALLS CHURCH, VA, 22040-0747, US

(73) Assignee: DX Antenna Company, Limited

(21) Appl. No.: 11/812,336

(22) Filed: Jun. 18, 2007

(30) Foreign Application Priority Data
Jun. 19, 2006 (JP) 2006-168939(P)

(51) Int. Cl. H01Q 21/00

(52) U.S. Cl. 343/867; 343/742

(57) ABSTRACT

In an antenna apparatus, a distance from a flat portion of a reflector to a second antenna along a first direction is not greater than a distance from the flat portion of the reflector to a first antenna along the first direction. In addition, a size of the first antenna viewed in the first direction is accommodated within a size of the entire reflector. By thus setting the size of the reflector, resonance of the second antenna can be prevented in spite of a short distance from the flat portion to the second antenna along the first direction. Therefore, lowering at a certain frequency, of gain of the first antenna can be prevented. Thus, an antenna apparatus achieving high performance and smaller size can be provided.

This nonprovisional application is based on Japanese Patent Application No. 2006-168939 filed with the Japan Patent Office on Jun. 19, 2006, the entire contents of which are hereby incorporated by reference.

### FIELD OF THE INVENTION

The present invention relates to an antenna apparatus, and more particularly to an antenna apparatus including two antennas different from each other in a frequency band for use.

### DESCRIPTION OF THE BACKGROUND ART

An antenna apparatus including two antennas different from each other in a frequency band for use has conventionally been known. For example, Japanese Patent Laying-Open No. 2003-008328 discloses an antenna apparatus including a UHF (Ultra High Frequency) antenna and a VHF (Very High Frequency) antenna.

This antenna apparatus further includes a reflector arranged between the UHF antenna and the VHF antenna. According to Japanese Patent Laying-Open No. 2003-008328, a shortest distance from a radiator to the UHF antenna is approximately 40 mm, and a shortest distance from the radiator to the VHF antenna is in a range from approximately 50 mm to approximately 100 mm.

In arranging the VHF antenna in the rear of the UHF antenna, it has conventionally been necessary to set the distance between the VHF antenna and the UHF antenna as long as possible. If the distance between the UHF antenna and a rod antenna is short, resonance of the VHF antenna may cause gain of the UHF antenna at a certain frequency to be significantly lower than gain thereof at other frequencies. In order to avoid resonance of the VHF antenna, the conventional antenna apparatus has been designed such that the distance between the VHF antenna and the UHF antenna is set as long as possible.

As the distance between the UHF antenna and the VHF antenna is greater, however, the antenna apparatus becomes larger in size. Japanese Patent Laying-Open No. 2003-008328 is silent about a method of preventing a greater size of the antenna apparatus while preventing lowering in characteristics of the UHF antenna (lowering in gain at a certain frequency).

### SUMMARY OF THE INVENTION

An object of the present invention is to provide an antenna apparatus achieving high performance and smaller size.

The present invention is directed to an antenna apparatus, including a first antenna adopting a first frequency band as a frequency band for use; a second antenna adopting, as the frequency band for use, a second frequency band lower than the first frequency band; and a reflector arranged between the first and second antennas, for reflecting radio wave received from a side of the first antenna. The reflector includes at least a flat portion. The flat portion is arranged such that a distance from the flat portion to the second antenna along a first direction perpendicular to the flat portion is equal to or smaller than a distance from the flat portion to the first antenna along the first direction. The flat portion has such a size that the entire first antenna is projected thereon if the first antenna is projected on the flat portion along the first direction.

Preferably, the first antenna includes first and second twin loop antennas and a feeding portion for phase difference feed to the first and second twin loop antennas.

More preferably, each of the first and second twin loop antennas has first and second loop antennas. At least one of the first and second loop antennas is arranged at an angle greater than 0 with respect to a second direction perpendicular to the first direction.

Each of the first and second twin loop antennas has first and second loop antennas.

Each of the first and second loop antennas has a loop surface in parallel to the first direction.

More preferably, the first antenna further includes a director guiding to the first and second twin loop antennas, radio wave transmitted from a transmission side.

More preferably, the second antenna is a linear dipole antenna.

Preferably, the reflector further includes a peripheral portion in contact with at least a part of a periphery of the flat portion and inclined toward the first antenna with respect to the flat portion.

Preferably, the antenna apparatus further includes a mixer arranged between the first antenna and the reflector, for mixing output from the first antenna and output from the second antenna. At least some of electronic components constituting the mixer are mounted on a main surface of a substrate. The substrate is arranged such that the main surface is opposed to the flat portion.

Preferably, the first frequency band is a UHF (Ultra High Frequency) band, and the second frequency band is a VHF (Very High Frequency) band.

Therefore, the primary advantage of the present invention resides in a smaller size of the antenna apparatus with improved performance.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a top view of an antenna apparatus according to a first embodiment.

FIG. 2 is a perspective view of the antenna apparatus according to the first embodiment.

FIG. 3 illustrates a shape of a radiator 2A in FIG. 1.

FIG. 4 illustrates an exemplary configuration of a mixer 10 shown in FIG. 1.

FIG. 5 is a top view of an antenna apparatus 1 for illustrating a size of a reflector 3.

FIG. 6 is a side view of antenna apparatus 1 for illustrating a size of reflector 3.

FIG. 7 illustrates gain of an antenna 2 with a width W2 and a length L of reflector 3 being varied.

FIG. 8 illustrates difference in gain of antenna 2 when the shape of reflector 3 is varied.

FIG. 9 shows a comparative example of the antenna apparatus in the first embodiment.

FIG. 10 illustrates gain of antenna 2 in antenna apparatus 1 and gain of antenna 2 in an antenna apparatus 1A.

FIG. 11 illustrates VSWR of antenna 2 in antenna apparatus 1 and VSWR of antenna 2 in antenna apparatus 1A.

FIG. 12 shows a comparative example where arrangement of the antenna apparatus and the mixer is different from that in the first embodiment.

FIG. 13 more specifically shows arrangement of the mixer in the first embodiment.

FIG. 14 is a perspective view of an antenna apparatus according to a second embodiment.

FIG. 15 shows a state where a lid 51 is removed from an antenna apparatus 1C shown in FIG. 14.

FIG. 16 illustrates a structure of radiators 2A and 2B included in antenna apparatus 1C according to the second embodiment.

FIG. 17 is a plan view illustrating an exemplary dimension of antenna apparatus 1C according to the second embodiment.

FIG. 18 is a side view of a portion including radiator 2B, reflector 3 and an antenna 4 in antenna apparatus 1C shown in FIG. 14.

### DESCRIPTION OF THE PREFERRED EMBODIMENTS

An embodiment of the present invention will be described hereinafter in detail with reference to the drawings. In the drawings, the same or corresponding elements have the same reference characters allotted.

### First Embodiment

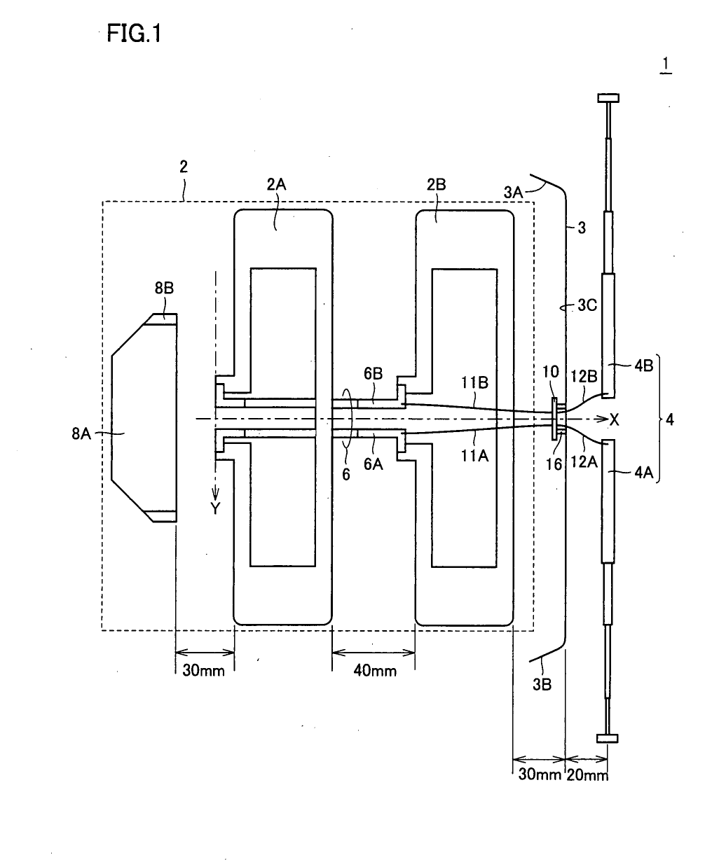

FIG. 1 is a top view of an antenna apparatus according to a first embodiment.

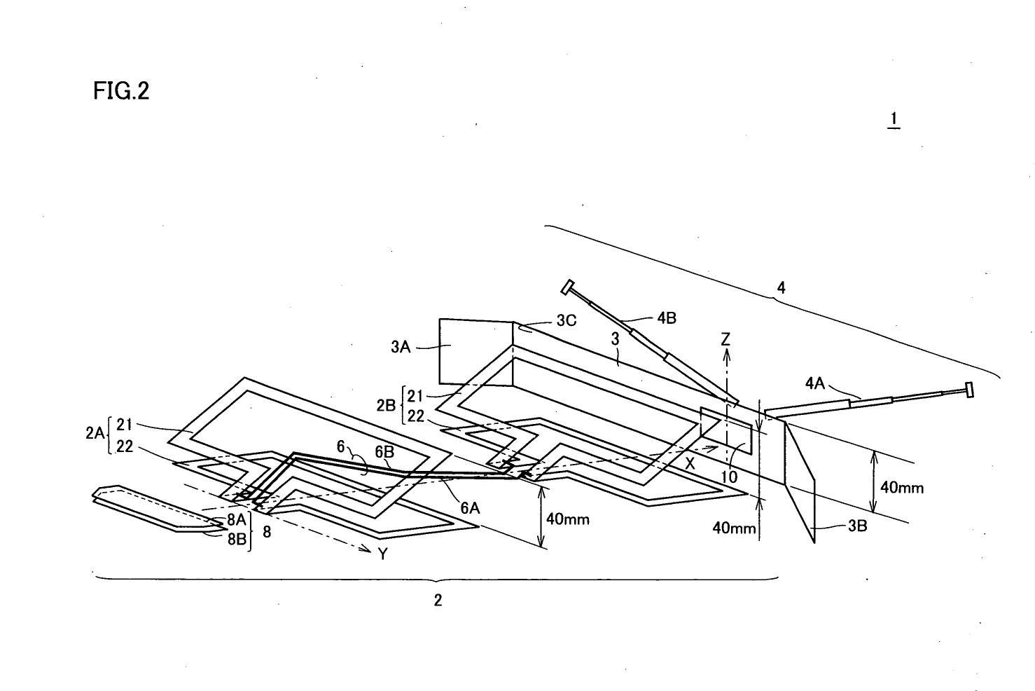

FIG. 2 is a perspective view of the antenna apparatus according to the first embodiment.

Referring to FIGS. 1 and 2, an antenna apparatus 1 includes antennas 2 and 4, a reflector 3, a feeding portion 6, a mixer 10, conductors 11A, 11B, 12A, and 12B, and a fixing member 16.

A direction of X-axis shown in FIGS. 1 and 2 indicates a direction from antenna 2 to antenna 4. In addition, a direction of Y-axis shown in FIGS. 1 and 2 indicates a direction perpendicular to the X-axis. A direction of Z-axis shown in FIG. 2 indicates a direction perpendicular to the X-axis direction. The Y-axis is orthogonal to the Z-axis. Here, the X-axis direction and the Z-axis direction correspond to the “first direction” and the “second direction” in the present invention, respectively.

In the description below, the “frequency band for use of antenna” refers to a frequency band in which reception (or transmission) of radio wave can suitably be performed with the use of that antenna. The frequency band for use of antenna 2 is the UHF band. The frequency band for use of antenna 4 is the VHF band. Namely, the frequency band for use of antenna 4 is lower than the frequency band for use of antenna 2. It is noted that the frequency bands for use of antennas 2 and 4 are not limited to the UHF band and the VHF band respectively, and the frequency bands for use should only be different from each other.

Antenna 2 includes radiators 2A and 2B. Radiators 2A and 2B are twin loop antennas. Each of radiators 2A and 2B includes two loop antennas 21 and 22. By employing the twin loop antennas as radiators 2A and 2B, gain and front-to-back ratio of antenna 2 can be improved as compared with a case using a linear dipole antenna as radiators 2A and 2B. Namely, performance of antenna 2 can be enhanced by employing the twin loop antennas as radiators 2A and 2B.

In the first embodiment, two loop antennas 21 and 22 are integrally formed. At least one of loop antennas 21 and 22 is arranged at an angle greater than 0 with respect to the Z-axis direction. More specifically, as shown in FIG. 2, radiators 2A and 2B are set in a bent state. For example, an angle between two loop antennas 21 and 22 is set to approximately 30 degrees.

By thus forming radiators 2A and 2B, the dimension in the Z-axis direction of antenna apparatus 1 can be made smaller. Namely, according to the first embodiment, antenna apparatus 1 can be smaller in thickness.

Reflector 3 is arranged between antenna 2 and antenna 4 and reflects radio wave received from antenna 2 side and guides the same to the radiator. Reflector 3 includes peripheral portions 3A and 3B and a flat portion 3C. Peripheral portions 3A and 3B are in contact with two end portions of flat portion 3C, that are located on opposing sides relative to the Z-axis. In addition, peripheral portions 3A and 3B are inclined toward antenna 2 with respect to flat portion 3C. Here, the X-axis direction is perpendicular to flat portion 3C.

In antenna apparatus 1, a distance from flat portion 3C of reflector 3 to antenna 4 along the X-axis direction is not greater than a distance from flat portion 3C of reflector 3 to antenna 2 along the X-axis direction. In addition, the size of antenna 2 viewed in the X-axis direction is accommodated within the size of entire reflector 3. By thus setting the size of reflector 3, resonance of antenna 4 can be prevented in spite of a short distance from flat portion 3C to antenna 4 along the X-axis direction. Therefore, lowering in gain of antenna 2 at a certain frequency can be prevented. According to the first embodiment, the antenna apparatus achieving high performance and smaller size can thus be provided.

Here, what is meant by the phrase “the size of antenna 2 viewed in the X-axis direction is accommodated within the size of entire reflector 3” is the same as such a state that entire antenna 2 is hidden by reflector 3 when reflector 3 is viewed in a direction from antenna 4 to antenna 2. In other words, when antenna 2 is projected on flat portion 3C in the direction from antenna 2 to antenna 4, entire antenna 2 is projected on flat portion 3C.

As the size of reflector 3 is greater, an effect to reflect the radio wave toward antenna 2 is enhanced, which means that the effect to prevent resonance of antenna 4 is enhanced. As the size of reflector 3 is greater, however, the size of antenna apparatus 1 becomes greater. Therefore, the size of reflector 3 can appropriately be determined, depending on performance and size required in antenna apparatus 1.

The distance from flat portion 3C to antenna 4 is set, for example, to approximately 20 mm. In the first embodiment, for example, the distance from flat portion 3C to antenna 4 may be as short as approximately 10 mm. The distance from flat portion 3C to antenna 2 is set, for example, to approximately 30 mm. Here, the “distance from flat portion 3C to antenna 2” refers to the distance from flat portion 3C to radiator 2B. In addition, the distance between radiators 2A and 2B is set, for example, to approximately 40 mm.

A width of reflector 3 along the Z-axis direction is set, for example, to approximately 40 mm. A width of antenna 2 along the Z-axis direction, that is, a width of radiator 1A (2B) along the Z-axis direction, is set, for example, to approximately 40 mm.

Reflector 3 is fabricated, for example, by bending a peripheral portion of one metal plate. The portions bent in the metal plate correspond to peripheral portions 3A and 3B. An angle between peripheral portion 3A and flat portion 3C is set, for example, to 70 degrees. Similarly, an angle between peripheral portion 3B and flat portion 3C is set, for example, to 70 degrees.

Reflector 3 may not include the bent peripheral portion. Namely, reflector 3 may simply be formed as a flat plate. By providing peripheral portions 3A and 3B in reflector 3, reflector 3 attains a function as what is called a corner reflector.

The corner reflector is more effective in reflecting the radio wave toward antenna 2, than the flat reflector. Therefore, according to the first embodiment, an effect to suppress resonance of antenna 4 can further be enhanced. In addition, according to the first embodiment, by bending the peripheral portion of reflector 3, a greater size of antenna apparatus 1 can be avoided.

Here, so long as the peripheral portion is provided in at least a part of the periphery of flat portion 3C, the number of peripheral portions or a position of the peripheral portion is not particularly limited.

Antenna 4 is a linear dipole antenna. Antenna 4 includes radiation elements 4A and 4B. More specifically, radiation elements 4A and 4B are rod antennas. Radiation elements 4A and 4B have a variable length, for example, in a range from approximately 650 mm to approximately 1050 mm. As shown in FIG. 2, according to the first embodiment, inclination of radiation elements 4A and 4B can be varied. Therefore, for example, orientation of radiation elements 4A and 4B can be varied so as to attain best reception sensitivity in receiving the radio wave.

Feeding portion 6 includes conductors 6A and 6B. Conductor 6A connects one feeding point of radiator 2A and one feeding point of radiator 2B with each other. Conductor 6B connects the other feeding point of radiator 2A and the other feeding point of radiator 2B with each other. Conductors 6A and 6B constitute what is called a “parallel line”.

Feeding portion 6 carries out phase difference feed to radiators 2A and 2B. By appropriately setting the width and length of each of conductors 6A and 6B as well as the distance between conductors 6A and 6B, when antenna 2 receives the radio wave, a signal output from radiator 2A is in phase with a signal output from radiator 2B. Gain of antenna 2 can thus be improved.

It is noted that the width of conductors 6A and 6B is set, for example, to approximately 3 mm, the distance between conductors 6A and 6B is set, for example, to approximately 3 mm, and the length of conductors 6A and 6B is set, for example, to approximately 130 mm.

Each of conductors 6A and 6B is connected to radiators 2A and 2B in a bent manner. By thus forming conductors 6A and 6B, the width in the Z-axis direction in antenna apparatus 1 does not increase in spite of the long length of conductors 6A and 6B, and antenna apparatus 1 can be smaller in thickness.

Antenna 2 further includes a director 8 guiding to radiators 2A and 2B, the radio wave transmitted from the transmission side. By providing director 8 in front of radiator 2A (on the side opposite to reflector 3 with respect to radiator 2A), gain and a front-to-back ratio of antenna 2 can be enhanced. The distance between director 8 and radiator 2A is set, for example, to approximately 30 mm.

Director 8 includes director elements 8A and 8B. Director elements 8A and 8B are aligned along the Z-axis direction. FIG. 1 shows director elements 8A and 8B different in size (director element 8B greater than director element 8A), however, director elements 8A and 8B may be identical in size.

It is noted that antenna 2 does not necessarily have to include the director. Whether or not the director is provided in antenna 2 is determined, depending on performance required in antenna 2 (such as gain).

Mixer 10 is arranged between antenna 2 and reflector 3. Mixer 10 mixes the output from antenna 2 with the output from antenna 4. Mixer 10 is fixed to reflector 3 by means of fixing member 16.

As shown in FIG. 1, mixer 10 and conductor 6A are connected to each other via conductor 11A. Mixer 10 and conductor 6B are connected to each other via conductor 11B. A signal output from antenna 2 can thus be supplied to mixer 10. Similarly, mixer 10 and radiation element 4A are connected to each other via conductor 12A. Mixer 10 and radiation element 4B are connected to each other via conductor 12B. A signal output from antenna 4 can thus be supplied to mixer 10.

A shape of radiators 2A and 2B before they are bent will now be described. It is noted that radiator 2B has a shape the same as radiator 2A. Therefore, radiator 2A will be illustrated in the following, and description of radiator 2B will not be repeated.

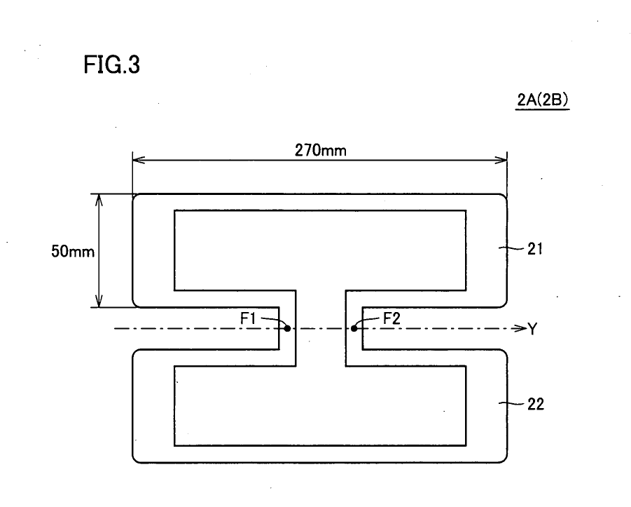

FIG. 3 illustrates the shape of radiator 2A in FIG. 1.

Referring to FIG. 3, radiator 2A includes loop antennas 21 and 22. Radiator 2A further has feeding points F1 and F2. Radiator 2A is bent along the Y-axis extending through feeding points F1 and F2. Here, the Y-axis shown in FIG. 3 corresponds to the Y-axis shown in FIGS. 1 and 2.

Each of radiator 2A and radiator 2B may be fabricated by connecting open ends of two loop antennas 21 and 22 to each other, that are separately prepared.

Loop antennas 21 and 22 have impedance of approximately 300Ω. In radiator 2A, as loop antennas 21 and 22 are connected in parallel, radiator 2A has impedance of approximately 150Ω. Similarly, radiator 2B has impedance of approximately 155Ω. In addition, as radiators 2A and 2B are connected in parallel by means of feeding portion 6, antenna 2 has impedance of approximately 75%.

Thus, in the first embodiment, the impedance of antenna 2 is set to approximately 75Ω. Meanwhile, a coaxial cable generally used as a communication cable has impedance of 50Ω or 75Ω in many cases.

Namely, according to the first embodiment, as a coaxial cable having impedance of 75Ω can directly be connected to antenna 2, the number of parts of the antenna apparatus can be reduced. In order to adjust impedance of antenna 2, however, a balun having a conversion ratio of 1:1 may be connected between feeding points F1 and F2.

For impedance matching between antenna 4 shown in FIG. 1 and the coaxial cable having impedance of 75Ω, for example, a balun having a conversion ratio of 1:4 is provided between radiation elements 4A, 4B and conductors 12A, 12B.

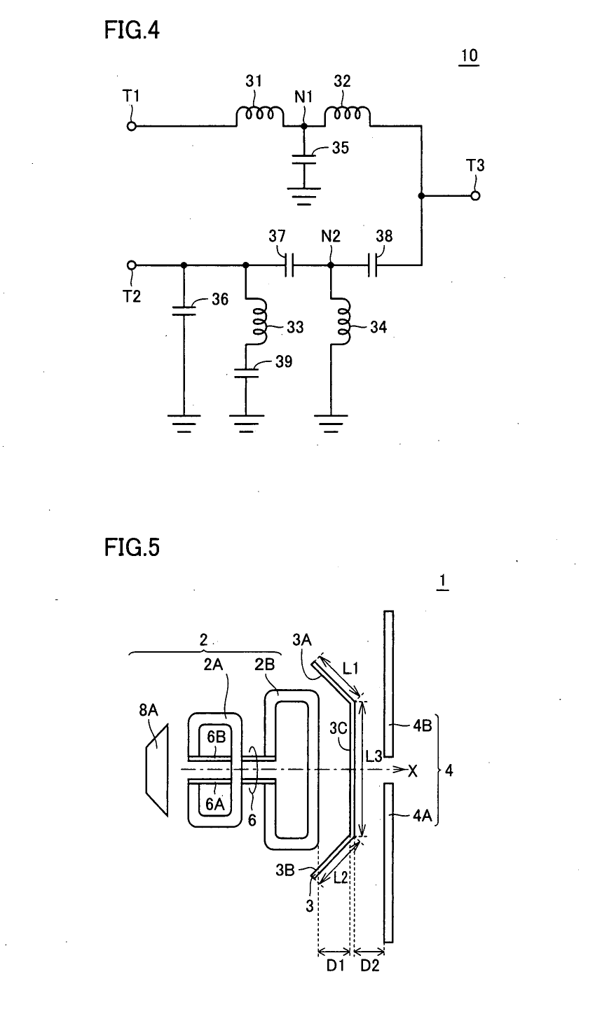

FIG. 4 illustrates an exemplary configuration of mixer 10 shown in FIG. 1.

Referring to FIG. 4, mixer 10 includes terminals T1 to T3, inductors 31 to 34, and capacitors 35 to 39.

Terminal T1 is supplied with the output from antenna 4. Terminal T2 is supplied with the output from antenna 2. Terminal T3 is supplied with a mixed signal generated as a result of mixing the output from antenna 4 and the output from antenna 2 together.

Inductor 31 is connected between terminal T1 and a node N1. Inductor 32 is connected between node N1 and terminal T3. Capacitor 35 has one end connected to node N1 and the other end connected to ground.

Capacitor 36 has one end connected to terminal T2 and the other end connected to ground. Inductor 33 has one end connected to terminal T2 and the other end connected to one end of capacitor 39. Capacitor 39 has the other end connected to ground.

Capacitor 37 is connected between terminal T2 and a node N2. Inductor 34 has one end connected to node N2 and the other end connected to ground. Capacitor 38 is connected between node N2 and terminal T3.

Variation in gain of antenna 2 depending on the size of reflector 3 will now be described.

FIG. 5 is a top view of antenna apparatus 1 for illustrating the size of reflector 3.

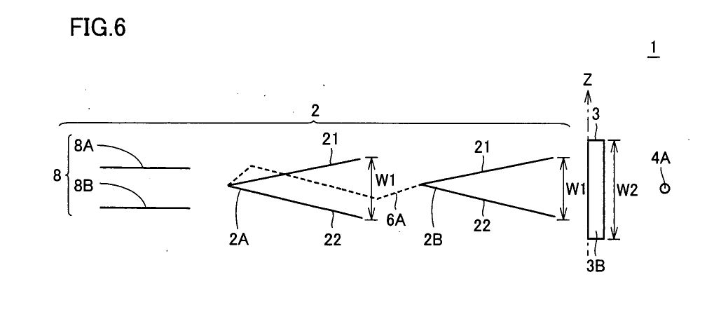

FIG. 6 is a side view of antenna apparatus 1 for illustrating the size of reflector 3.

Among the components of antenna apparatus 1, FIGS. 5 and 6 show antenna 2 (radiators 2A, 2B), reflector 3 (peripheral portions 3A, 3B and flat portion 3C), antenna 4 (radiation elements 4A, 4B), feeding portion 6 (conductors 6A, 6B), and director 8 (director elements 8A, 8B). For the sake of convenience of illustration, FIGS. 5 and 6 do not show mixer 10, conductors 11A, 11B, 12A, and 12B, and fixing member 16.

Initially, referring to FIG. 5, L1 and L2 represent lengths of peripheral portions 3A and 3B of reflector 3 respectively, and L3 represents a length of flat portion 3C of reflector 3. It is noted that the sum of L1, L2 and L3 (L1+L2+L3) is hereinafter referred to as “length L of reflector 3.”

FIG. 5 further shows a distance D1 from flat portion 3C to radiator 2B along the X-axis direction and a distance D2 from flat portion 3C to antenna 4 along the X-axis direction. Distance D1 is set to approximately 30 mm, while distance D2 is set to approximately 20 mm. In summary, distance D2 is not greater than distance D1. It is noted that the X-axis shown in FIG. 5 corresponds to the X-axis shown in FIGS. 1 and 2.

Referring next to FIG. 6, W1 represents a width of radiator 2A (2B) along the Z-axis direction. In the description below, W1 is set to approximately 40 mm. W2 represents a width of reflector 3 along the Z-axis direction. It is noted that the Z-axis shown in FIG. 6 corresponds to the Z-axis shown in FIGS. 1 and 2.

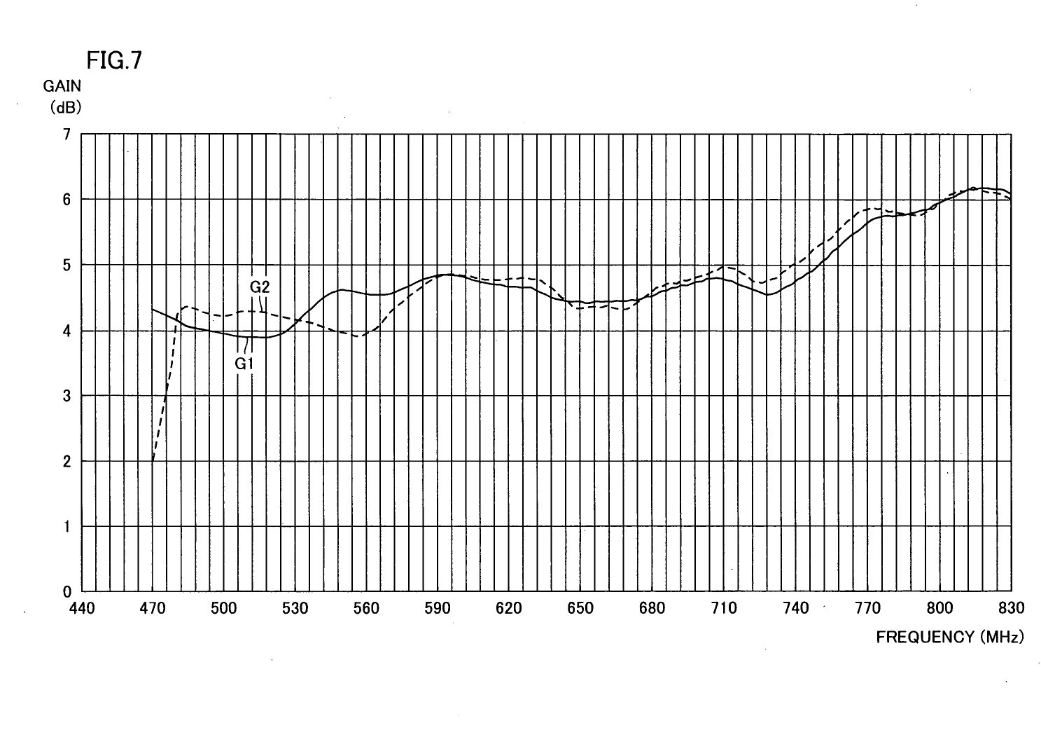

FIG. 7 illustrates gain of antenna 2 with width W2 and length L of reflector 3 being varied.

Referring to FIG. 7, curves G1 and G2 represent variation in gain of antenna 2 with respect to frequencies. Here, the frequency shown in the graph of FIG. 7 is in a range from 440 to 830 MHz. This range includes the frequency band of the UHF television broadcast in Japan (470 MHz to 770 MHz) and the frequency band of the UHF television broadcast in the United States (470 MHz to 806 MHz).

Curve G1 shows variation in gain of antenna 2 with respect to frequencies when width W2 of reflector 3 is set to approximately 40 mm and length L of reflector 3 is set to approximately 340 mm. Here, L1 and L2 are set to approximately 30 mm, and L3 is set to approximately 280 mm. Meanwhile, width W2 (approximately 40 mm) is not smaller than width W1 (approximately 40 mm). Here, the size of antenna 2 viewed in the X-axis direction is accommodated within the size of entire reflector 3.

Curve G2 shows variation in gain with respect to frequencies when width W2 of reflector 3 is set to approximately 30 mm and length L of reflector 3 is set to approximately 280 mm. Length L of reflector 3 of approximately 280 mm means that peripheral portions 3A and 3B are not provided in reflector 3 (flat portion 3C serves as reflector 3 itself). Width W2 (approximately 30 mm) is smaller than width W1 (approximately 40 mm). Here, the size of antenna 2 viewed in the X-axis direction is greater than the size of entire reflector 3.

It is noted that, when curves G1 and G2 are obtained, the length of each of radiation elements 4A and 4B is set to approximately 1050 mm.

As shown with curve G2, if width W2 of reflector 3 is smaller than width W1 of antenna 2, gain of antenna 2 at a frequency around 470 MHz is significantly lower than gain of antenna 2 at other frequencies. This is because resonance of antenna 4 has occurred at the frequency around 470 MHz.

Meanwhile, as shown with curve G1, if width W2 of reflector 3 is not smaller than width W1 of antenna 2, lowering in gain of antenna 2 at the frequency around 470 MHz does not occur. Namely, it can be seen from curves G1 and G2 that resonance of antenna 4 can be prevented by setting the size of entire reflector 3 such that the size of antenna 2 viewed in the X-axis direction is accommodated within the size of entire reflector 3.

Variation in gain of antenna 2 depending on the size of reflector 3 will be described with reference to yet another example.

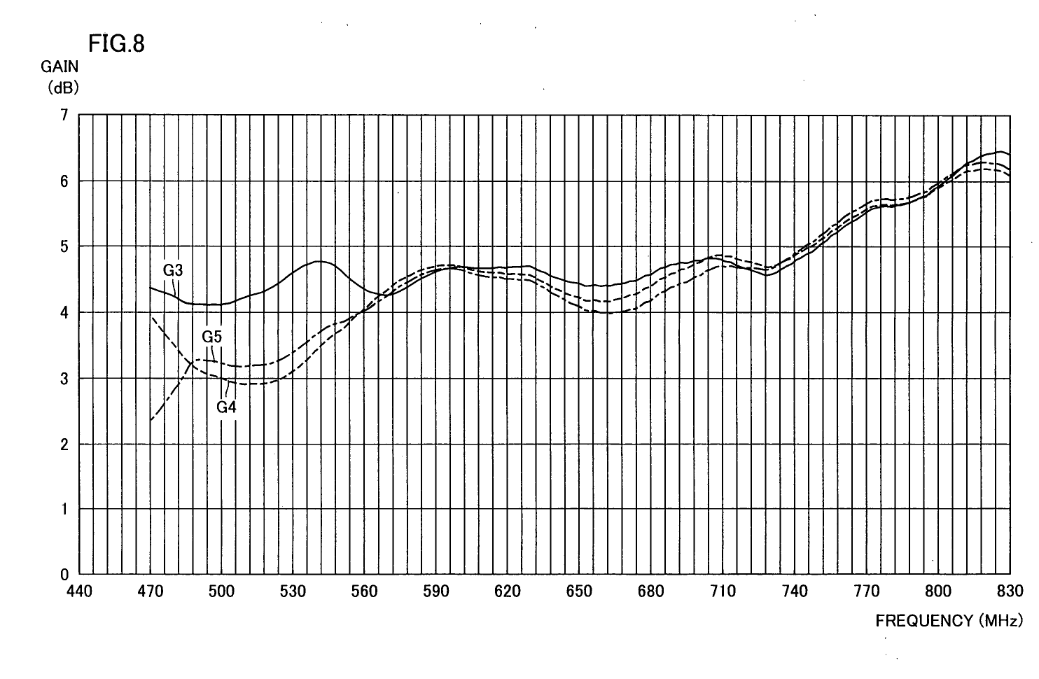

FIG. 8 illustrates difference in gain of antenna 2 when the shape of reflector 3 is varied.

Referring to FIGS. 8 and 6, curves G3 to G5 represent variation in gain of antenna 2 depending on frequencies. Curve G3 shows frequency characteristics of gain of antenna 2 when reflector 3 has width W2 of approximately 40 mm and length L of approximately 340 mm. Curve G4 shows frequency characteristics of gain of antenna 2 when reflector 3 is not provided in antenna apparatus 1.

Curve G5 shows frequency characteristics of gain of antenna 2 when a reflector obtained by annularly winding an AWG (American Wire Gauge) wire is employed instead of reflector 3. Here, the entire length of the AWG wire is approximately 625 mm. Here, the width of the reflector (length in the Z-axis direction shown in FIG. 6) fabricated by annularly winding the AWG wire is small. Therefore, in this case, the size of antenna 2 viewed in the X-axis direction is greater than the size of entire reflector 3.

It is noted that, when curves G3 to G5 are obtained, each of radiation elements 4A and 4B has a length of approximately 730 mm.

Initially, it can be seen from curve G3 and curve G4 that gain of antenna 2 in a frequency range from approximately 470 to approximately 560 MHz is improved by providing reflector 3 between antenna 2 and antenna 4. In addition, it can be seen from curve G3 and curve G5 that, as to gain of antenna 2 in the frequency range from approximately 470 to approximately 560 MHz, gain shown with curve G3 is higher than gain shown with curve G5. Namely, if the reflector fabricated by annularly winding the AWG wire is employed, resonance of antenna 4 occurs. Resonance of antenna 4, however, can be prevented by setting the size of entire reflector 3 such that the size of antenna 2 viewed in the X-axis direction is accommodated within the size of entire reflector 3, as in the first embodiment.

Variation in gain of antenna 2 depending on the size of reflector 3 will be described with reference to yet another example.

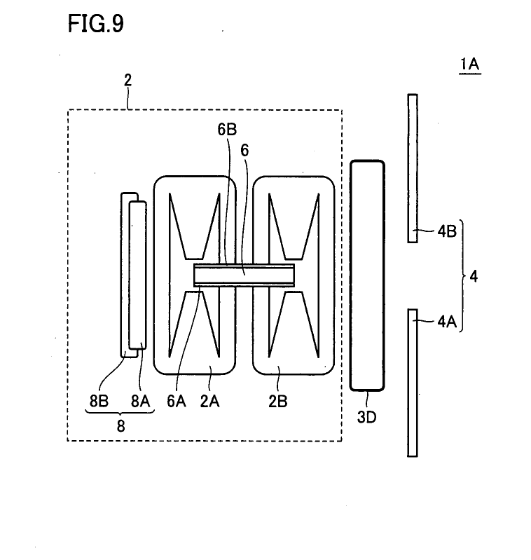

FIG. 9 shows a comparative example of the antenna apparatus in the first embodiment.

Referring to FIGS. 9 and 5, an antenna apparatus 1A and antenna apparatus 1 are different from each other in the shape of radiators 2A and 2B. In addition, antenna apparatus 1A is different from antenna apparatus 1 in including a reflector 3D formed in a loop shape instead of reflector 3. As the structure of other portions of antenna apparatus 1A is the same as the structure of corresponding portions of antenna apparatus 1, description thereof will not be repeated. It is noted that a width (length in the Z-axis direction shown in FIG. 6) of reflector 3D is smaller than width W2 of reflector 3 shown in FIG. 6.

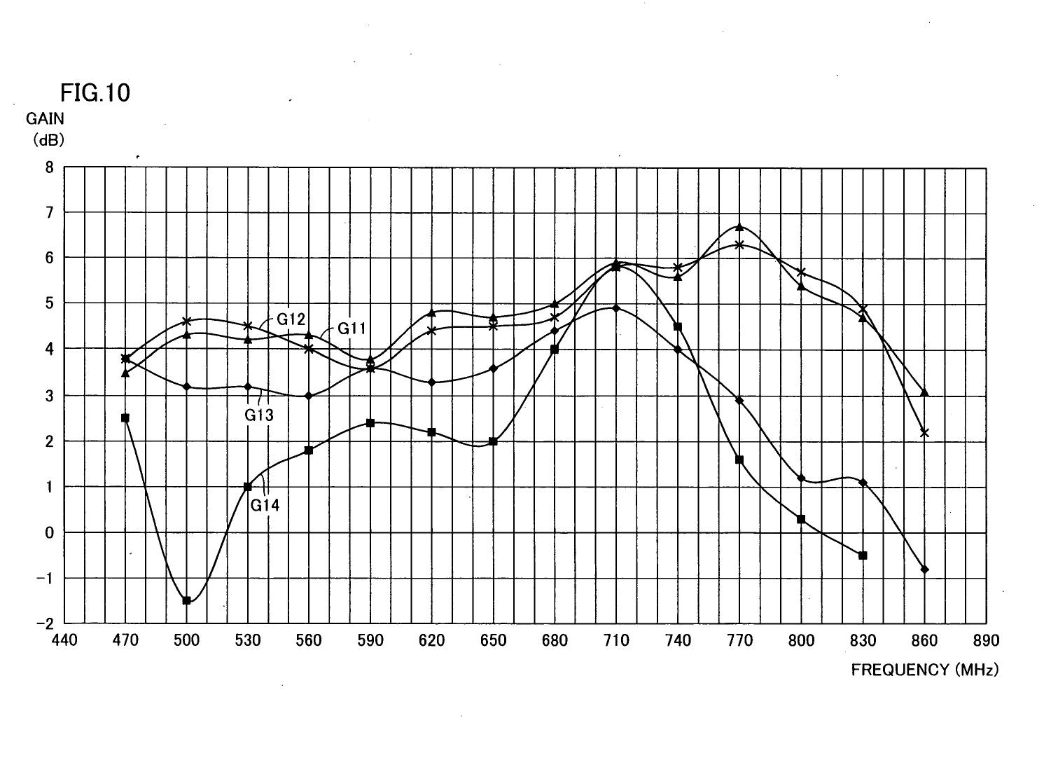

FIG. 10 illustrates gain of antenna 2 in antenna apparatus 1 and gain of antenna 2 in antenna apparatus 1A.

Referring to FIG. 10, curves G11 to G14 show variation in gain in a frequency range from 470 to 860 MHz.

Curve G11 shows frequency characteristics of gain of antenna 2 when antenna 4 is not provided in antenna apparatus 1. Curve G12 shows frequency characteristics of gain of antenna 2 when antenna 4 is included in antenna apparatus 1. Here, when curves G11 and G12 are obtained, reflector 3 has width W2 of approximately 40 mm and length L of approximately 340 mm. Curve G13 shows frequency characteristics of gain of antenna 2 when antenna 4 is not provided in antenna apparatus 1A. Curve G14 shows frequency characteristics of gain of antenna 2 when antenna 4 is included in antenna apparatus 1A.

As shown with curves G11 and G12, in antenna apparatus 1, the frequency characteristics of gain of antenna 2 hardly vary regardless of presence/absence of antenna 4. Meanwhile, as shown with curves G13 and G14, in the comparative examples, gain of antenna 2 around a frequency of 500 MHz is significantly lower by bringing antenna 4 closer to antenna 2. This is because resonance of antenna 4 has occurred.

The comparative example is different from the first embodiment in the shape of radiators 2A and 2B. Lowering in gain of antenna 2 in the comparative example, however, is attributed to the fact that the size of antenna 2 viewed in the X-axis direction is greater than the size of entire reflector 3.

Thus, in antenna apparatus 1 of the first embodiment, the size of entire reflector 3 is determined such that the size of antenna 2 viewed in the X-axis direction is accommodated within the size of entire reflector 3. Therefore, according to the first embodiment, lowering in gain of antenna 2 due to resonance of antenna 4 can be prevented even though antenna 4 is brought closer to antenna 2. Consequently, according to the first embodiment, an antenna apparatus achieving high performance and smaller size can be provided.

Relation between other characteristics of antenna 2 and the size of reflector 3 will now be described. In the following, VSWR (voltage standing wave ratio) is shown as representing other characteristics of antenna 2. Here, as a value of VSWR is lower, performance of antenna 2 is higher.

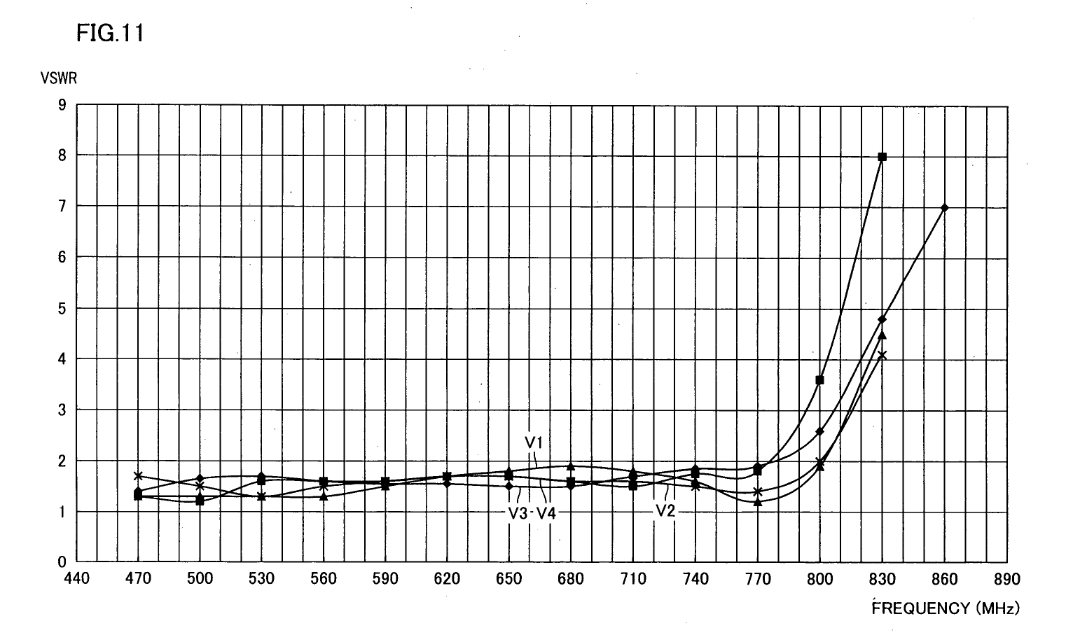

FIG. 11 illustrates VSWR of antenna 2 in antenna apparatus 1 and VSWR of antenna 2 in antenna apparatus 1A.

Referring to FIG. 11, curves V1 to V4 show variation in VSWR in a frequency range from 470 to 860 MHz. Curve V1 shows frequency characteristics of VSWR of antenna 2 when antenna 4 is not provided in antenna apparatus 1 in FIG. 5. Curve V2 shows frequency characteristics of VSWR of antenna 2 when antenna 4 is included in antenna apparatus 1. When curves V1 and V2 are obtained, reflector 3 has width W2 of approximately 40 mm and length L of approximately 340 mm. Curve V3 shows frequency characteristics of VSWR of antenna 2 when antenna 4 is not provided in antenna apparatus 1A. Curve V4 shows frequency characteristics of VSWR of antenna 2 when antenna 4 is included in antenna apparatus 1A.

As shown with curves V1 to V4, there is no great difference between VSWR of antenna 2 in antenna apparatus 1 (the first embodiment) and VSWR of antenna 2 in antenna apparatus 1A (comparative example).

In general, if the value of VSWR is in a range from approximately 2.5 to 3, a practical problem does not arise. As shown with curves V1 and V2, the value of VSWR in the frequency range from 470 to 806 MHz is substantially not larger than 3. As described above, this range includes the frequency band of the UHF television broadcast in Japan and the frequency band of the UHF television broadcast in the United States. In summary, it can be seen from curves V1 and V2 that the VSWR characteristic of antenna 2 included in antenna apparatus 1 in the first embodiment does not give rise to a practical problem.

Next, the reason why mixer 10 is provided between antenna 2 and reflector 3 in the antenna apparatus according to the first embodiment will be described.

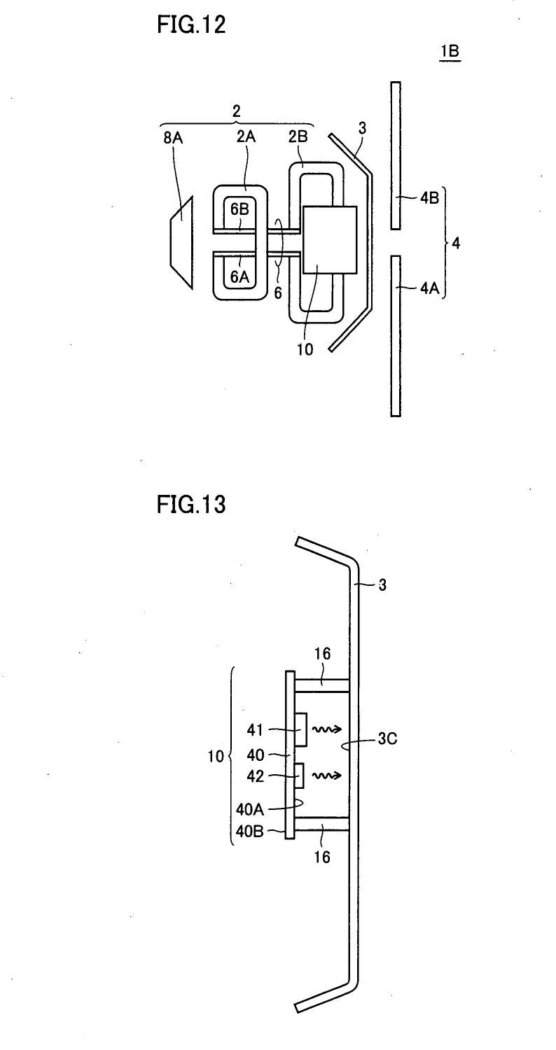

FIG. 12 shows a comparative example where arrangement of the antenna apparatus and the mixer is different from that in the first embodiment.

Referring to FIG. 12, mixer 10 is arranged on radiator 2B in an antenna apparatus 1B: As shown in FIG. 4, mixer 10 includes various electronic components (inductors 31 to 34, capacitors 35 to 39, and the like) mounted on a substrate. In general, as an area of the substrate is greater, an area of a conductor region (such as a ground pattern and an interconnection pattern) on the main surface of the substrate is greater. If a large conductor is brought closer to radiator 2B, performance of radiator 2B (that is, performance of antenna 2) may lower.

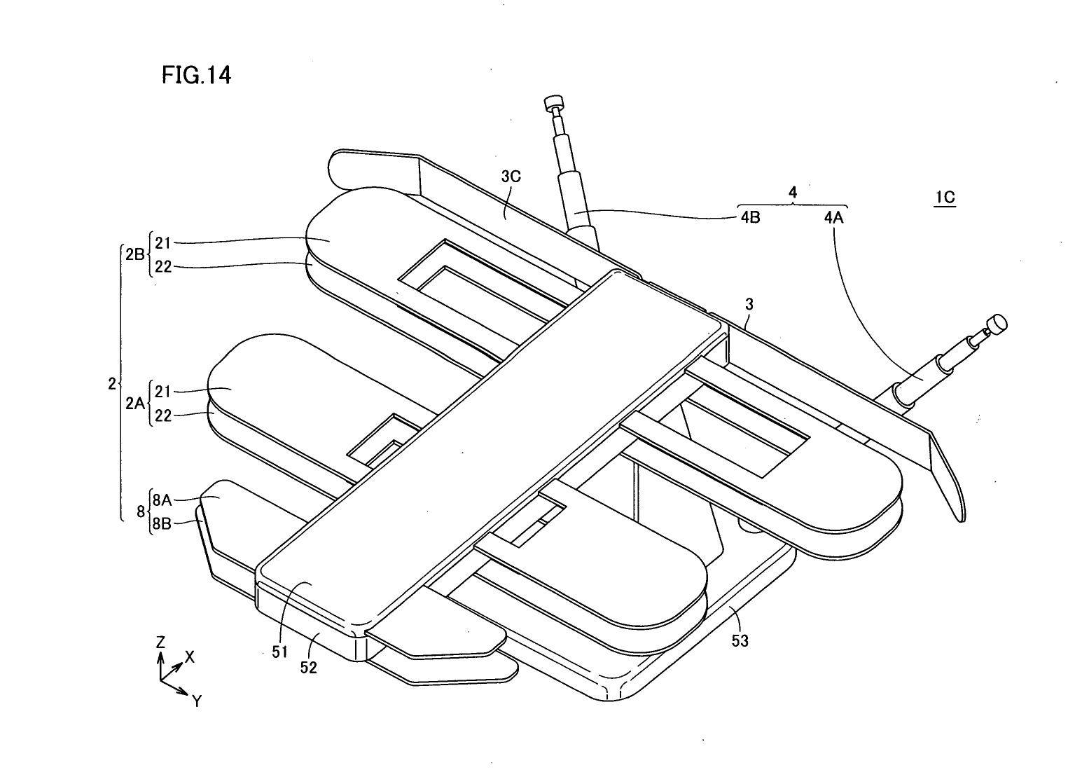

FIG. 13 more specifically shows arrangement of the mixer in the first embodiment.

Referring to FIG. 13, mixer 10 includes a substrate 40 and electronic components 41 and 42. Substrate 40 has main surfaces 40A and 40B. Main surface 40A is opposed to flat portion 3C of reflector 3. Electronic components 41 and 42 are mounted on main surface 40A. Namely, a conductor region is formed on main surface 40A. Electronic components 41 and 42 refer to inductors 31 to 34, capacitors 35 to 39, and the like shown in FIG. 4. Here, substrate 40 is fixed to reflector 3 by means of a plurality of fixing members 16.

Main surface 40A and reflector 3 are opposed to each other so that the conductor region of substrate 40 is distant from antenna 2. Therefore, according to the first embodiment, the characteristics of antenna 2 can be prevented from lowering. In addition, as reflector 3 serves as a shield case for electronic components 41 and 42, influence of radiation from electronic components 41 and 42 onto antenna 2 can be avoided. For the above-described reasons, according to the first embodiment, mixer 10 can be mounted on antenna apparatus 1 without affecting the characteristics of antenna 2.

An amplifier for amplifying output of mixer 10 may be mounted on main surface 40A. Here, reflector 3 also serves as a shield case for the amplifier. Therefore, influence of radiation from the amplifier onto antenna 2 can be avoided.

As described above, according to the first embodiment, even if two antennas different in the frequency band for use are brought closer to each other, resonance of one antenna out of the two antennas, that is adapted to lower frequency band for use, can be prevented. Therefore, according to the first embodiment, an antenna apparatus achieving high performance and smaller size can be provided.

### Second Embodiment

FIG. 14 is a perspective view of an antenna apparatus according to a second embodiment.

Referring to FIGS. 14 and 1, an antenna apparatus 1C is different from antenna apparatus 1 in further including a lid 51, a case 52, and a base portion 53. It is noted that the X-axis direction, the Y-axis direction and the Z-axis direction shown in FIG. 14 are the same as the X-axis direction, the Y-axis direction and the Z-axis direction shown in FIG. 2 respectively.

As will be described later, feeding portion 6 and mixer 10 shown in FIG. 1 are stored in case 52. In addition, director 8 (director elements 8A, 8B) and radiators 2A and 2B (loop antennas 21 and 22) included in antenna 2 are attached to case 52.

Case 52 and antenna 4 (radiation elements 4A and 4B) are attached to base portion 53. Base portion 53 is provided in order to set antenna apparatus 1C on a prescribed plane (for example, on a desk).

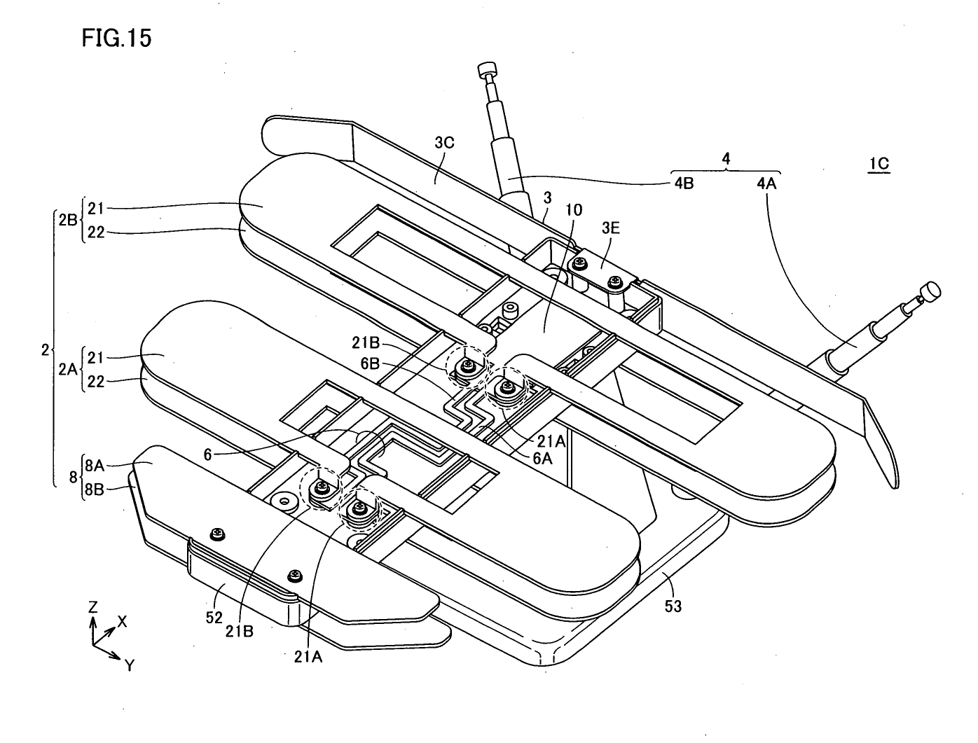

FIG. 15 shows a state where lid 51 is removed from antenna apparatus 1C shown in FIG. 14. It is noted that the X-axis direction, the Y-axis direction and the Z-axis direction shown in FIG. 15 are the same as the X-axis direction, the Y-axis direction and the Z-axis direction shown in FIG. 2 respectively.

Referring to FIGS. 15 and 14, feeding portion 6 (conductors 6A and 6B) is stored in case 52. Conductors 6A and 6B are formed in a meandering manner, at a constant distance from each other.

A notch (recess) is formed in an edge of case 52 in conformity with the shape of loop antenna 21. By placing loop antenna 21 in the notch, lid 51 can be fitted over case 52 without interference of loop antenna 21.

Loop antenna 21 has coupling portions 21A and 21B. Coupling portions 21A and 21B are bent and screwed to case 52. Loop antenna 22 also includes two coupling portions having a shape the same as coupling portions 21A and 21B shown in FIG. 15.

On the side of radiator 2A, one end of conductor 6A, coupling portion 21A of loop antenna 21, and one coupling portion of loop antenna 22 are fastened to case 52 by means of one screw. Meanwhile, on the side of radiator 2A, one end of conductor 6B, coupling portion 21B of loop antenna 21, and the other coupling portion of loop antenna 22 are fastened to case 52 by means of one screw.

On the side of radiator 2B, the other end of conductor 6A, coupling portion 21A of loop antenna 21, one coupling portion of loop antenna 22, and an end portion of mixer 10 (circuit substrate) are fastened to case 52 by means of one screw. Meanwhile, on the side of radiator 2B, the other end of conductor 6B, coupling portion 21B of loop antenna 21, the other coupling portion of loop antenna 22, and another end portion of mixer 10 (circuit substrate) are fastened to case 52 by means of one screw.

Reflector 3 has a coupling portion 3E coupled to flat portion 3C of reflector 3. Coupling portion 3E is fastened to case 52 by means of a screw. Reflector 3 is thus fixed to case 52.

As the structure of other portions of antenna apparatus 1C shown in FIGS. 14 and 15 is the same as that of corresponding portions of antenna apparatus 1, description thereof will not be repeated.

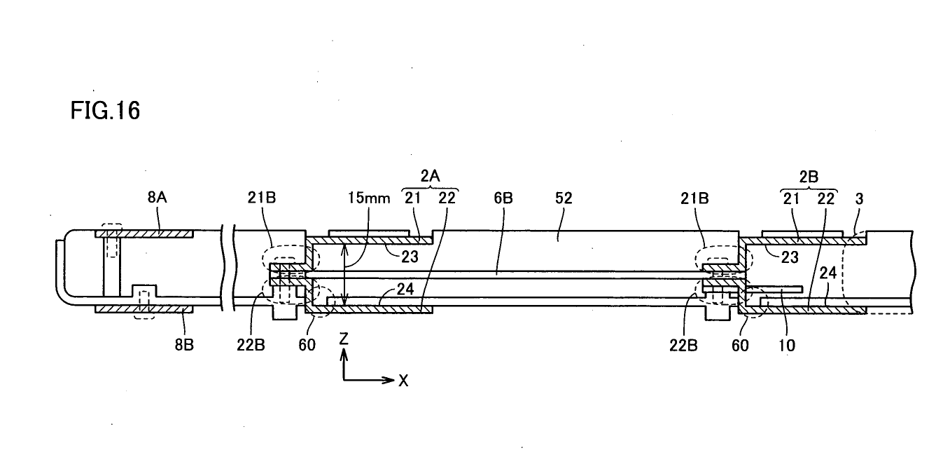

FIG. 16 illustrates a structure of radiators 2A, 2B included in antenna apparatus 1C according to the second embodiment. FIG. 16 shows a part of a cross-section when case 52 is divided into two parts along the X direction in FIG. 15. Here, the X-axis direction and the Z-axis direction shown in FIG. 16 are the same as the X-axis direction and the Z-axis direction shown in FIG. 15 respectively.

Referring to FIGS. 15 and 16, loop antenna 21 included in each of radiators 2A and 2B is provided such that a loop surface 23 thereof is in contact with an upper edge of case 52. Meanwhile, loop antenna 22 included in each of radiators 2A and 2B is provided such that a loop surface 24 thereof is in contact with a bottom surface of case 52. Thus, the loop surfaces of loop antennas 21, 22 are in parallel to each other and in parallel to the X-axis direction. According to the second embodiment, a distance between loop antennas 21 and 22 (distance in the Z-axis direction between two loop surfaces) can thus be made smaller than in the first embodiment. For example, as shown in FIG. 16, the distance in the Z-axis direction between loop antennas 21 and 22 is set to approximately 15 mm. Thus, according to the second embodiment, the antenna apparatus can be made smaller in thickness than in the first embodiment.

A structure on the side of radiator 2A will now be described. The end portion of conductor 6B is screwed to case 52 in such a manner as sandwiched between coupling portion 21B of loop antenna 21 and coupling portion 22B of loop antenna 22.

Similarly, a structure on the side of radiator 2B will be described. The end portion of conductor 6B is sandwiched between coupling portion 21B of loop antenna 21 and coupling portion 22B of loop antenna 22. In addition, mixer 10 (circuit substrate) is provided between coupling portion 22B and case 52. On the side of radiator 2B, coupling portion 21B, the end portion of conductor 6B, coupling portion 22B, and the circuit substrate are screwed to case 52.

Conductor 6B is provided so as not to be in contact with the bottom of case 52. Thus, occurrence of loss in conductor 6B during the operation of antenna 2 can be prevented.

On both radiator 2A and radiator 2B sides, coupling portions 21B and 22B and conductor 6B are fixed to case 52 by means of one screw. Therefore, an opening 60 through which coupling portion 22B passes from the outside to the inside of case 52 is provided in the bottom surface of case 52.

Director element 8A is supported on the upper edge of case 52 and screwed to case 52. Director element 8B is in contact with the bottom surface of case 52 and screwed to case 52. In addition, the length of reflector 3 along the Z-axis direction is not smaller than the distance between loop antennas 21 and 22.

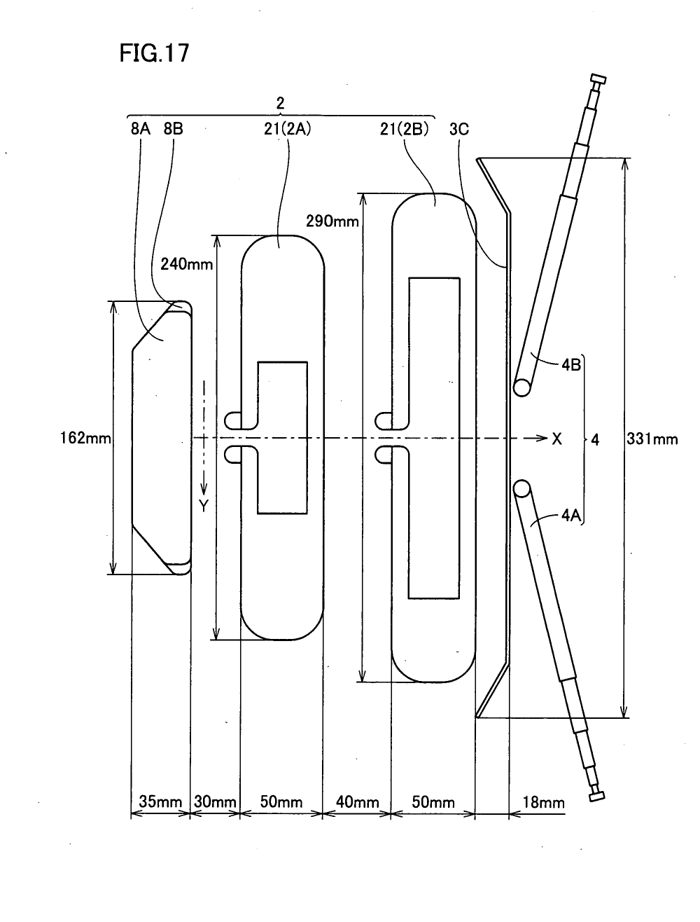

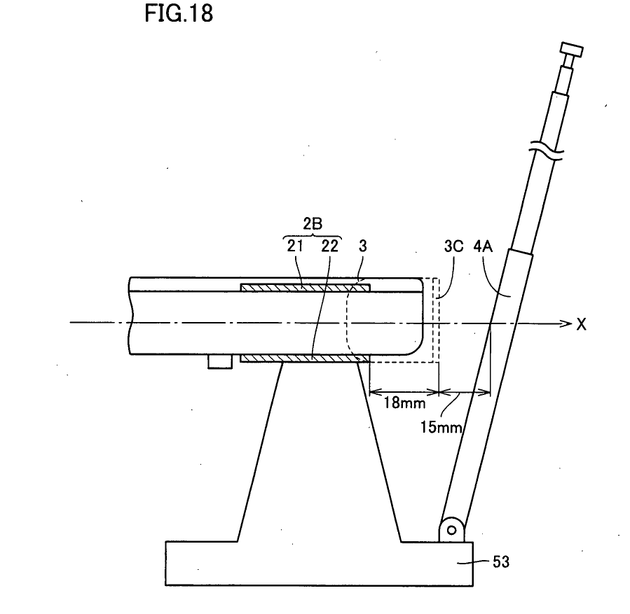

FIG. 17 is a plan view illustrating an exemplary dimension of antenna apparatus 1C according to the second embodiment.

FIG. 18 is a side view of a portion including radiator 2B, reflector 3 and antenna 4 in antenna apparatus 1C shown in FIG. 14.

Referring to FIGS. 17 and 18, the distance from flat portion 3C to antenna 2 (distance from flat portion 3C to radiator 2B) is set to approximately 18 mm. Meanwhile, antenna 4 is attached to base portion 53, in proximity to flat portion 3C.

The X-axis shown in FIG. 18 refers to an axis extending in the direction the same as the X-axis shown in FIG. 17 and it is equidistant from loop antennas 21 and 22. It is noted that FIG. 18 solely shows radiation element 4A out of radiation elements 4A and 4B constituting antenna 4 (as radiation element 4B is overlapped with radiation element 4A, it is not shown in FIG. 18). Even if the distance from flat portion 3C to antenna 4 (radiation elements 4A, 4B) along the X-axis is as small as approximately 15 mm, lowering in gain of antenna 2 due to resonance of antenna 4 can be prevented. Thus, in the antenna apparatus according to the second embodiment as well, the distance from flat portion 3C to antenna 4 is smaller than the distance from flat portion 3C to antenna 2. It is noted that the distance from flat portion 3C to antenna 4 along the X-axis may be longer than approximately 15 mm (for example, approximately 20 mm) so that antenna 4 does not affect the characteristics of antenna 2.

Reflector 3 has a length along the Y-axis direction of approximately 331 mm. Loop antenna 21 included in radiator 2A has a length in the Y-axis direction of approximately 240 mm. Loop antenna 21 included in radiator 2B has a length in the Y-axis direction of approximately 290 mm.

Namely, reflector 3 has a length in the Y-axis direction longer than that of loop antenna 21. In addition, as shown in FIG. 16, reflector 3 has a length in the Z-axis direction longer than the distance between loop antennas 21 and 22 along the Z-axis direction.

Therefore, as in the first embodiment, in the antenna apparatus according to the second embodiment, the size of antenna 2 viewed in the X-axis direction is also accommodated within the size of entire reflector 3. Namely, according to the antenna apparatus of the second embodiment, even if antenna 4 is brought closer to antenna 2, lowering in gain of antenna 2 due to resonance of antenna 4 can be prevented. Therefore, according to the second embodiment, an antenna apparatus achieving high performance and smaller size can be provided.

Dimensions of other portions of antenna apparatus 1C will be described. The distance between radiators 2A and 2B is set to approximately 40 mm. Radiators 2A and 2B have a length in the X-axis direction of approximately 50 mm. The distance between director 8 (director elements 8A and 8B) and radiator 2A is set to approximately 30 mm. Director elements 8A and 8B have a length in the X-axis direction of approximately 35 mm. Director element 8B has the largest dimension in the Y-axis direction of approximately 162 mm. The largest dimension in the Y-axis direction of director element 8A is slightly smaller than approximately 162 mm. It is noted that the dimensions shown in FIGS. 17 and 18 are by way of example, and the dimensions may appropriately be modified depending on various conditions such as performance of the antenna apparatus.

As described above, in the second embodiment, two loop antennas included in the first antenna (antenna 2) are arranged such that the loop surfaces are in parallel to each other. Therefore, according to the second embodiment, an antenna apparatus having a size (thickness) further smaller than in the first embodiment can be provided.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An antenna apparatus, comprising:
a first antenna adopting a first frequency band as a frequency band for use;
a second antenna adopting, as the frequency band for use, a second frequency band lower than said first frequency band; and
a reflector arranged between said first and second antennas, for reflecting radio wave received from a side of said first antenna;
said reflector including at least a flat portion,
said flat portion being arranged such that a distance from said flat portion to said second antenna along a first direction perpendicular to said flat portion is equal to or smaller than a distance from said flat portion to said first antenna along said first direction, and
said flat portion having such a size that entire said first antenna is projected thereon if said first antenna is projected on said flat portion along said first direction.

2. The antenna apparatus according to claim 1, wherein
said first antenna includes
first and second twin loop antennas, and
a feeding portion for phase difference feed to said first and second twin loop antennas.

3. The antenna apparatus according to claim 2, wherein
each of said first and second twin loop antennas has first and second loop antennas, and
at least one of said first and second loop antennas is arranged at an angle greater than 0 with respect to a second direction perpendicular to said first direction.

4. The antenna apparatus according to claim 2, wherein
each of said first and second twin loop antennas has first and second loop antennas, and
each of said first and second loop antennas has a loop surface in parallel to said first direction.

5. The antenna apparatus according to claim 2, wherein
said first antenna further includes a director guiding to said first and second twin loop antennas, radio wave transmitted from a transmission side.

6. The antenna apparatus according to claim 2, wherein
said second antenna is a linear dipole antenna.

7. The antenna apparatus according to claim 1, wherein
said reflector further includes a peripheral portion in contact with at least a part of a periphery of said flat portion and inclined toward said first antenna with respect to said flat portion.

8. The antenna apparatus according to claim 1, further comprising a mixer arranged between said first antenna and said reflector, for mixing output from said first antenna and output from said second antenna;
at least some of electronic components constituting said mixer being mounted on a main surface of a substrate, and
said substrate being arranged such that said main surface is opposed to said flat portion.

9. The antenna apparatus according to claim 1, wherein
said first frequency band is a UHF (Ultra High Frequency) band, and
said second frequency band is a VHF (Very High Frequency) band.
